(19) United States
(12) Patent Application Publication
(10) Pub. No.: US 2009/0183830 A1
(43) Pub. Date: Jul. 23, 2009

(54) METHOD FOR PRINTING ON THIN PLASTIC SHELLS FOR HELMETS OR VEHICLE FASCIAS

(75) Inventor: Chao-Yi Hung, Taichung (TW)

Correspondence Address: PAI PATENT & TRADEMARK LAW FIRM, 1001 FOURTH AVENUE, SUITE 3200, SEATTLE, WA, 98154, US

(73) Assignee: TRANSART GRAPHICS CO., LTD., Taichung (TW)

(21) Appl. No.: 12/018,379

(22) Filed: Jan. 23, 2008

(51) Int. Cl. B32B 37/06

(52) U.S. Cl. 156/285

(57) ABSTRACT

A method for printing on thin plastic shells for helmets or vehicle fascias has the following steps. Preparing a colorful pattern board being preparing a colorful pattern board having a plastic board with a top and a bottom, a pattern layer and a melting layer. Forming a crude product by heating and attaching the colorful pattern board to a surface of an untreated shell by vacuum to obtain a crude product. Finally, a crude shell is modified. Accordingly, embellished thin plastic shells are obtained simply with fewer solvents.

### BACKGROUND OF THE INVENTION

1. Field of the Invention

The present invention relates to a method for printing colorful patterns on thin plastic shells, more particular to a method for printing colorful patterns on thin plastic shells used for vehicular body fascias or helmets.

2. Description of the Related Art

Conventional thin plastic shells being used for helmets and decorative fascias including, but not limited to decorative fascias for phone, scooters and the like and the thin plastic shells are made by injection molding but are monotonous. To embellish the shells, the shells are spray-painted and then colorful adhesives are attached to the painted cases. Finally, a protective varnish is sprayed on the cases.

However, such procedure is complicated, solvents for the paints pollute air and water and may cause to harm to humans and local environments. However, other methods for embellishing the thin plastic shells, such as hot pressing and the like are not suitable for thin plastic shells, especially since the plastic casings are generally contoured.

To overcome the shortcomings, the present invention provides a method for printing thin plastic shells to obviate or mitigate the aforementioned problems.

### SUMMARY OF THE INVENTION

The primary objective of the present invention is to provide a method for printing thin plastic shells for helmets or vehicle fascias. The method according to the present invention is simple and can enhance the thickness of the thin plastic shells for extra strength. Further, the method according to the present invention reduces solvent outlay therefore improving environmentally friendliness of the method.

The present invention relates to a method for printing on thin plastic shells for decorative fascias and has the following steps. Preparing a colorful pattern board being preparing a colorful pattern board having a plastic board with a top and a bottom, a pattern layer and a melting layer. Forming a crude product by heating and attaching the colorful pattern board to a surface of an untreated case by vacuum to obtain a crude shell. Finally, a crude case is modified. Accordingly an embellished thin plastic shells is simply obtained.

Other objectives, advantages and novel features of the invention will become more apparent from the following detailed description when taken in conjunction with the accompanying drawings.

### BRIEF DESCRIPTION OF THE DRAWINGS

FIG. 1 is a block diagram of a method for printing thin plastic shells in accordance with the present invention;

FIG. 2A is a perspective and cross sectional view of a thin plastic shells as step A of FIG. 1;

FIG. 2B is an enlarged cross sectional view of a thin plastic shells of FIG. 2B;

FIG. 3 is a perspective view of a thin plastic shell being molded as Step C of FIG. 1;

FIG. 4 is an enlarged perspective view of the shell in FIG. 3;

FIG. 5 is a perspective view of a final product formed from the shell in FIG. 4;

FIG. 6 is an enlarged cross sectional view of a final product of the present invention; and

FIG. 7 is a perspective view of a second embodiment of the present invention, shown mounted on a scooter being in phantom lines.

### DETAILED DESCRIPTION OF THE INVENTION

As defined herein, thin plastic shells are thin plastic shells less than 3 mm thick and may be used as a protective layer of and decoration for helmets, vehicular body fascias, telephone fascias and the like. In a preferred embodiment, the thickness of the thin plastic shells is about 0.5 to 3 mm thick.

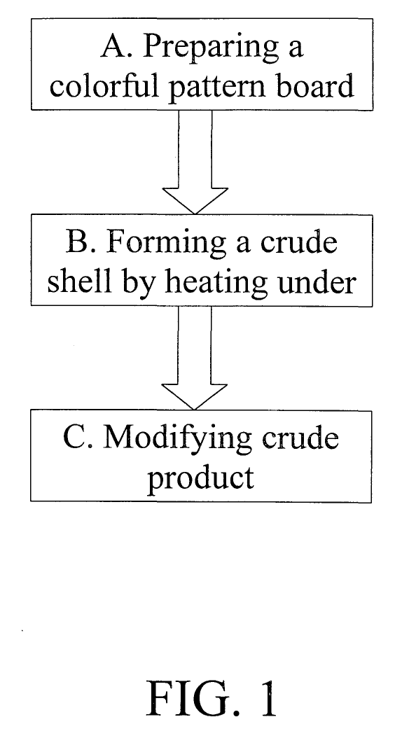

With reference to FIG. 1, the present invention relates to a method for printing thin plastic shells for helmets or vehicle fascias, and the method comprises (A) preparing a colorful pattern board; (B) forming a crude product by heating under vacuum and (C) modifying crude product.

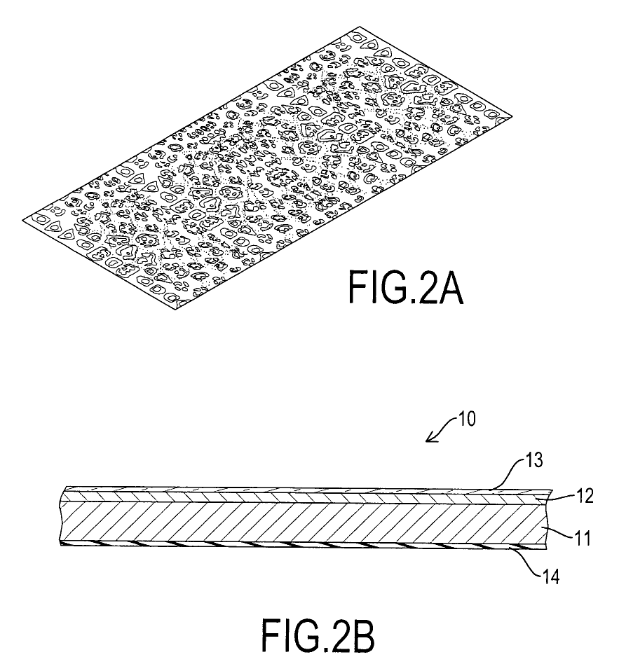

With further reference to FIGS. 2A and 2B, (A) preparing a colorful pattern board comprises preparing a colorful pattern board (10) comprising a plastic board (11), a pattern layer (12), a protective membrane (13) and a melting layer (14). The plastic board (11) has a top surface, a bottom surface and may be ABS, PC, PVC, PP or PET. The pattern layer (12) is mounted on the top surface of the plastic board (11) and has at least one pattern. Each pattern may be at least one word, letter, character, design, picture or the like. In a preferred embodiment of the present invention, the pattern may be a leopard spot pattern. The protective membrane (13) is mounted on the pattern layer (12) and may be transparent. The melting layer (14) is attached to the bottom surface of the plastic board (11). The melting layer (14) is used for combining the colorful pattern board (10) and a shell.

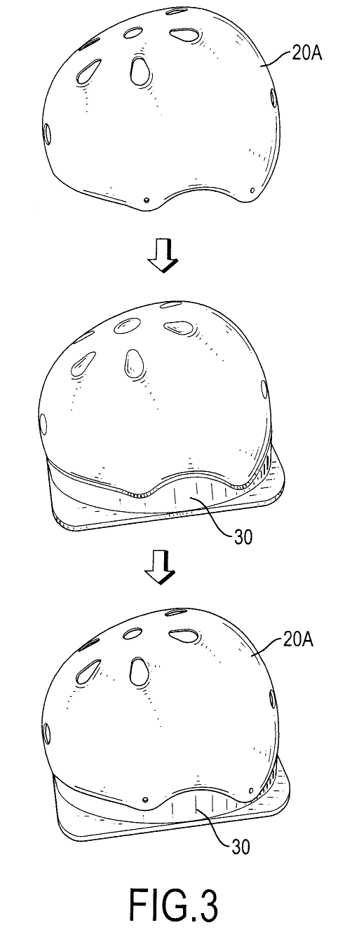

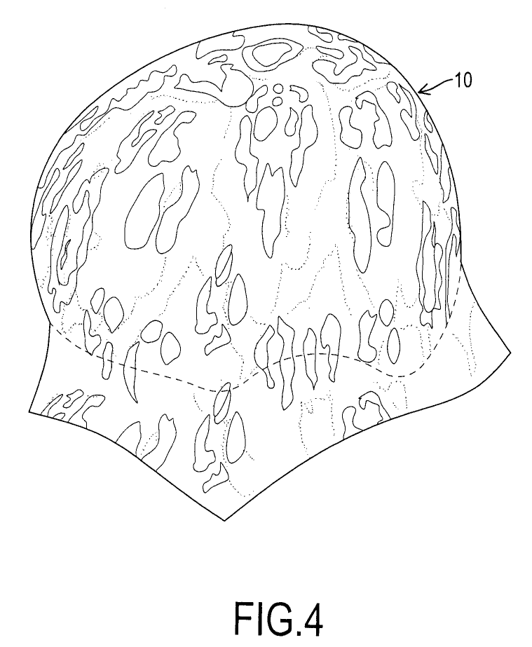

With further reference to FIGS. 3 and 4, (B) forming a crude product by heating under vacuum comprises obtaining an untreated shell (20A) having an inner and an outer surface and may be transparent and heating the untreated shell (20A) under vacuum. In a preferred embodiment of the present invention, the untreated shell (20A) is a helmet shell. The untreated shell (20A) is put in a mold (30) of a vacuum machine, the shape of the mold (30) matches the bottom of the untreated shell (20A). The colorful pattern board (10) is heated to a malleable colorful pattern board by the melting layer (14), the malleable colorful pattern board (10) is attached firmly on the surface of the untreated shell (20A) by vacuum machine to obtain a crude shell.

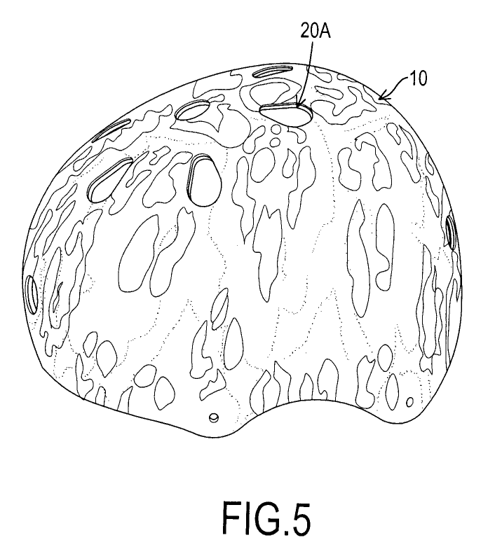

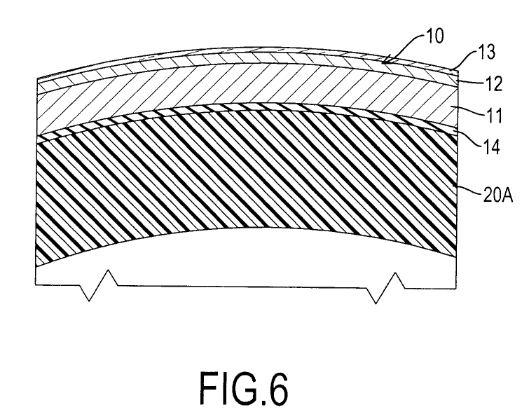

With further reference to FIGS. 5 and 6, (C) modifying the crude product comprises modifying and decorating the crude product to obtain a final product.

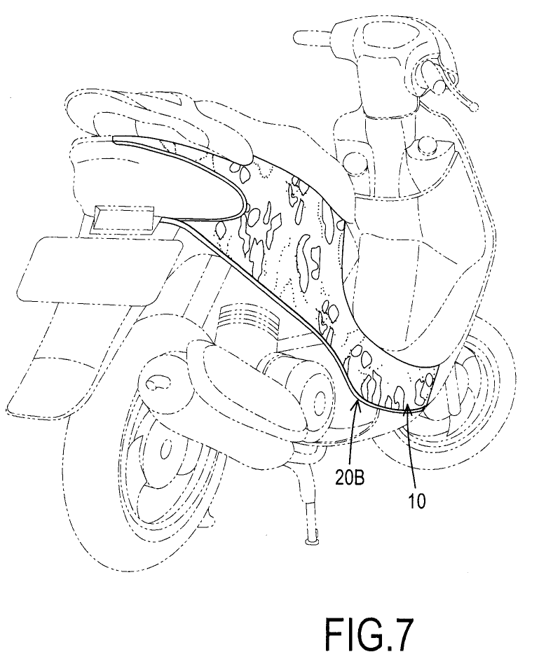

With reference to FIG. 7, the method disclosed by the present invention also could be applied on vehicle fascias to decorate the vehicle.

The method according to the present invention is simple and could be operated without protective membrane (13).

The present invention provides a simple way for embellishing a helmet or vehicle fascias without complex steps. Therefore, the present invention could be operated easily.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A method for printing on thin plastic shells for helmets or vehicle fascias, comprising
(A) preparing a colorful pattern board,
the colorful pattern board comprising
a plastic board having a top surface and a bottom surface;
a pattern layer mounted on the top surface of the plastic board comprising at least one pattern; and
a melting layer mounted on the bottom of the plastic board;
(B) forming a crude shell by heating under vacuum,
preparing an untreated shell having a surface on a mold of a vacuum machine;
heating the colorful pattern board to obtain a malleable colorful pattern board;
attaching the malleable colorful board to the surface of the untreated shell to obtain a crude shell; and
(C) modifying the crude shell to obtain a final product.

2. The method as claimed in claim 1, wherein the at least one pattern is at least one letter, word, character, design picture or mixture thereof.

3. The method as claimed in claim 2, wherein the colorful pattern board further comprises a protective layer mounted on the pattern layer.

4. The method as claimed in claim 3, wherein the protective layer is a transparent layer.

5. The method as claimed in claim 1, wherein the colorful pattern board further comprises a protective layer mounted on the pattern layer.

6. The method as claimed in claim 1, wherein
the untreated shell is transparent and has an inner surface; and
the pattern board is attached to the inner surface of the pattern board.

7. The method as claimed in claim 1, wherein
the untreated shell has an outer surface; and
the at least one pattern board is attached to the outer surface of the pattern board.
